(19) United States
(12) Patent Application Publication
(10) Pub. No.: US 2015/0021915 A1
(43) Pub. Date: Jan. 22, 2015

(54) APPARATUS AND SYSTEMS WHICH GENERATE ELECTRIC POWER FROM WIND

(71) Applicant: RE10 LTD., Gizo (IL)

(72) Inventors: Carmi Raz, Gizo (IL); Tzahi Shneider, Lachish (IL)

(73) Assignee: RE10 LTD., Gizo (IL)

(21) Appl. No.: 14/378,347

(22) PCT Filed: Feb. 19, 2013
(86) PCT No.: PCT/IB2013/051340

§ 371 Date: Aug. 13, 2014

Related U.S. Application Data
(60) Provisional application No. 61/600,717, filed on Feb. 20, 2012.

(51) Int. Cl. F03D 1/02; F03D 11/00; F03D 9/00; F03D 1/04; F03D 1/06

(52) U.S. Cl. CPC F03D 1/02; F03D 1/04; F03D 1/0608; F03D 9/002; F03D 11/0091; F03D 9/005
USPC 290/44; 415/220; 415/90; 415/222; 290/55

(57) ABSTRACT

An apparatus comprising: (a) a bladeless rotatable element with a smooth outer surface, said rotatable element connected to a drive mechanism; and (b) a dynamo powered by said drive mechanism so as to output an electric current.

### RELATED APPLICATION

The present application gains priority from U.S. Provisional Patent Application No. 61/600,717 filed 20 Feb. 2012.

### FIELD AND BACKGROUND OF THE INVENTION

This invention relates to apparatus, systems and methods which generate electric power from compressible fluid flows such as wind.

Developed countries rely heavily upon electric power for a variety of uses including, but not limited to, lighting, climate control, entertainment, communications and transportation.

In many cases electric power is generated by combustion of fossil fuels. As the price of these fuels rises, the price of electric power produced from them rises proportionately.

In areas where there is a supply of flowing water (e.g. in proximity to a river or dam), electric power can be generated by using the water flow to turn hydro-electric turbines. However, this solution is not always available, or sufficiently available, in proximity to major population centers.

Solar energy can also be harnessed to produce electricity either by using photovoltaic cells or by using mirrors to focus incident light rays so that the rays heat water to generate steam to power turbines. This solution is only available in areas where there is sufficient incident sunlight and is only available during daylight hours and/or during certain seasons of the year.

The potential to harness wind power has long been appreciated. Wind mills have been used to grind grain for hundreds of years. Similar mechanical designs have been used to pump water from wells. A large number of wind based generators for electricity have been described in the literature, but none of these proposed solutions has successfully competed with combustion of fossil fuels so far.

### SUMMARY OF THE INVENTION

A broad aspect of the invention relates to generation of electric power from kinetic energy in a flow of compressible fluid such as wind. In some embodiments, an array of small turbines is provided to capture energy from wind flowing through an available area. As used in this specification and the accompanying claims the term “turbine” indicates a rotatable element and a dynamo connected by a drive train which transfers rotational energy from the rotatable element to the dynamo. In some exemplary embodiments of the invention, the drive train is an axle extending from the rotatable element to the dynamo.

One aspect of some embodiments of the invention relates to reduction of noise and/or vibration associated with a wind powered electric turbine. In some exemplary embodiments of the invention, noise and/or vibration are reduced by installing a large number of small turbines including small rotatable elements per unit of surface area exposed to wind instead of a single turbine with a large rotatable element. Alternatively or additionally, in some exemplary embodiments of the invention noise and/or vibration are reduced by causing a portion of rotatable elements in an array of turbines to rotate in one direction (e.g. clockwise) and another portion of turbines in the same array of turbines to rotate in a second direction (e.g. counterclockwise). As used in this specification and the accompanying claims the term a “portion” indicates “at least one”. Alternatively or additionally, in some embodiments of the invention noise and/or vibration are reduced by providing rotatable elements with a smooth outer surface. Alternatively or additionally, in some embodiments of the invention noise and/or vibration are reduced by funneling air which would nominally pass between turbines into one or more turbines.

Another aspect of some embodiments of the invention relates to modular arrays of small turbines which are easily assembled in a desired configuration. In some embodiments, fast fit mechanisms or connectors contribute to easy assembly. As used in this specification and the accompanying claims the term “fast fit” indicates a mechanism or connector that can be assembled by an average person in 1 minute or less. In some embodiments, the fast fit mechanisms are reversible. Optionally, reversible fast fit mechanisms contribute to ease of changing individual units, or portions thereof, within the array.

Another aspect of some embodiments of the invention relates to small turbines (i.e. less than 1 kilowatt/hour) with a rotatable element connected to a dynamo by a fast fit connector. Another aspect of some embodiments of the invention relates to small turbines with a dynamo connected to a support structure by a fast fit connector. In some embodiments, the fast fit mechanisms are reversible. In some exemplary embodiments of the invention, reversible fat fit mechanisms contribute to ease of changing the rotatable element and/or the dynamo within a turbine.

Another aspect of some embodiments of the invention relates to monitoring of modular arrays of small turbines so that individual turbines in the array can be replaced or repaired in case of malfunction. In some embodiments, a visual indicator, such as an LED, indicates that a turbine is not functioning properly. Optionally, the LED is on an external portion of the array and/or on the individual turbine that has malfunctioned. Alternatively or additionally, in some embodiments a remote display indicates which arrays and/or which turbine(s) within an array is not functioning properly. Optionally, audible signals are used in addition to, or instead of, visual indicators.

It will be appreciated that the various aspects described above relate to solution of technical problems associated with rendering wind turbines acceptable for use on or near occupied structures.

Alternatively or additionally, it will be appreciated that the various aspects described above relate to solution of technical problems related to increasing efficiency of management of large numbers of small turbines.

In some exemplary embodiments of the invention, there is provided apparatus comprising: (a) a bladeless rotatable element with a smooth outer surface, the rotatable element connected to a drive mechanism; (b) a dynamo powered by the drive mechanism so as to output an electric current. In some embodiments, the drive mechanism includes a single axle connected to both the rotatable element and the dynamo. Alternatively or additionally, in some embodiments the dynamo resides within a volume defined by the rotatable element. Alternatively or additionally, in some embodiments the apparatus includes a funnel element adapted to direct airflow into one or more intake ports of the rotatable elements. Alternatively or additionally, in some embodiments the rotatable element has a diameter of less than 25 cm measured transverse to its connection to the drive mechanism. Alternatively or additionally, in some embodiments the rotation speed of the rotatable element is adjustable by disturbing airflow. Alternatively or additionally, in some embodiments a plurality of apparatus as described above are arranged in an array. In some embodiments, of such an array a first portion of rotatable elements in the array are adapted to rotate clockwise and a second portion of rotatable elements in the array are adapted to rotate counter clockwise.

In some exemplary embodiments of the invention, there is provided an apparatus including: (a) an array of contiguous turbine housings and (b) a plurality of turbines installed in the housings, wherein a rotatable element in a first portion of the turbines is adapted to rotate clockwise and a rotatable element in a second portion of the turbines is adapted to rotate counter clockwise. In some embodiments, the rotatable elements are bladeless. Alternatively or additionally, in some embodiments the rotation speed of the rotatable element is adjustable by disturbing air flow. Alternatively or additionally, in some embodiments the rotatable elements have a smooth outer surface. Alternatively or additionally, in some embodiments the rotatable elements are circumscribed by a sleeve. Alternatively or additionally, in some embodiments the rotatable element of each of the turbines includes an axle powering a dynamo so as to output an electric current. Alternatively or additionally, in some embodiments a dynamo of each of the turbines resides within a volume defined by the rotatable element. Alternatively or additionally, in some embodiments the apparatus includes a funnel element adapted to direct an airflow from between the turbines into one or more of the turbines. Alternatively or additionally, in some embodiments the array includes at least 16 turbines per M².

In some exemplary embodiments of the invention, there is provided a kit including: a plurality of turbine modules, each of the modules including at least one turbine and a surrounding support structure; each of the turbine modules provided with a fast fit mechanism adapted for attachment to at least one additional turbine module. In some embodiments, a first portion of the modules include exclusively turbines with a rotatable element adapted to rotate clockwise and a second portion of the modules include exclusively turbines with a rotatable element adapted to rotate counter clockwise. Alternatively or additionally, in some embodiments at least a portion of the modules include at least one turbine with a rotatable element adapted to rotate clockwise and at least one turbine with a rotatable element adapted to rotate counter clockwise. Alternatively or additionally, in some embodiments each of the turbines in the module includes a fast fit mechanism coupling the dynamo to the rotatable element. Alternatively or additionally, in some embodiments each of the at least one turbine is provided as a pre-assembled turbine comprising a fast fit mechanism attachable to the surrounding support structure. Alternatively or additionally, in some embodiments each of the plurality of turbine modules is provided un-assembled.

In some exemplary embodiments of the invention, there is provided an apparatus including a support structure including a number of turbine receptacles arranged in an array; a corresponding number of turbines engaged and retained in the receptacles, each turbine having a bladeless rotatable element; and a fast fit mechanism connecting the bladeless rotatable element to a drive train of each of the turbines. In some embodiments, the apparatus includes a fast fit mechanism connecting a dynamo of each of the turbines to the support structure. Alternatively or additionally, in some embodiments the apparatus includes a corresponding number of wind funnels connected to the support structure, each of the wind funnels adapted to direct a flow of air towards the rotatable element. Alternatively or additionally, in some embodiments the apparatus includes a fast fit mechanisms which connect the wind funnels to the support structure. Alternatively or additionally, in some embodiments the apparatus includes a cover plate with a corresponding number of wind funnels adapted and arranged to direct a flow of air towards the rotatable element, the cover plate connected to the support structure. Alternatively or additionally, in some embodiments the apparatus includes a fast fit mechanisms which connects the cover plate to the support structure.

In some exemplary embodiments of the invention, there is provided a system comprising: (a) a plurality of turbines installed in an array of contiguous housings; (b) a current monitor measuring an output current from a dynamo of each of the turbines; (c) logic circuitry adapted to receive measurements from the current monitor and determine if one or more turbines in the plurality malfunctions and indicate malfunctions to a reporting mechanism; and (d) the reporting mechanism. In some embodiments, the logic circuitry is adapted to determine which of the turbines malfunctions and identify the malfunctioning turbine(s) to the reporting mechanism. Alternatively or additionally, in some embodiments the logic circuitry includes a program module installed on a microprocessor. Alternatively or additionally, in some embodiments the reporting mechanism includes one or more visual indicators. Alternatively or additionally, in some embodiments the reporting mechanism issues a digital announcement. Alternatively or additionally, in some embodiments a rotatable element of each of the turbines has a diameter of less than 35 cm measured transverse to its connection to a drive mechanism.

In some exemplary embodiments of the invention, there is provided a system including one or more apparatus or systems as described hereinabove; (b) a switch transferring an output current from the apparatus or systems to a power grid through an inverter; and (c) at least one other power source transferring an output current to the grid through the switch.

Unless otherwise defined, all technical and scientific terms used herein have the same meaning as commonly understood by one of ordinary skill in the art to which this invention belongs. Although suitable methods and materials are described below, methods and materials similar or equivalent to those described herein can be used in the practice of the present invention. In case of conflict, the patent specification, including definitions, will control. All materials, methods, and examples are illustrative only and are not intended to be limiting.

As used herein, the terms “comprising” and “including” or grammatical variants thereof are to be taken as specifying inclusion of the stated features, integers, actions or components without precluding the addition of one or more additional features, integers, actions, components or groups thereof This term is broader than, and includes the terms “consisting of” and “consisting essentially of” as defined by the Manual of Patent Examination Procedure of the United States Patent and Trademark Office.

The phrase “adapted to” as used in this specification and the accompanying claims imposes additional structural limitations on a previously recited component.

The term “method” refers to manners, means, techniques and procedures for accomplishing a given task including, but not limited to, those manners, means, techniques and procedures either known to, or readily developed from known manners, means, techniques and procedures by practitioners of architecture and/or computer science.

Implementation of the method and system of the present invention involves performing or completing selected tasks or steps manually, automatically, or a combination thereof. Moreover, according to actual instrumentation and equipment of preferred embodiments of methods, apparatus and systems of the present invention, several selected steps could be implemented by hardware or by software on any operating system of any firmware or a combination thereof For example, as hardware, selected steps of the invention could be implemented as a chip or a circuit (e.g. ASICS). As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

In order to understand the invention and to see how it may be carried out in practice, embodiments will now be described, by way of non-limiting example only, with reference to the accompanying figures. In the figures, identical and similar structures, elements or parts thereof that appear in more than one figure are generally labeled with the same or similar references in the figures in which they appear. Dimensions of components and features shown in the figures are chosen primarily for convenience and clarity of presentation and are not necessarily to scale. The attached figures are:

FIG. 1 is a perspective view of an exemplary rotatable element according to some embodiments of the invention configured to rotate clockwise;

FIG. 2 is a perspective view of an exemplary rotatable element similar to that depicted in FIG. 1, but configured to rotate counter-clockwise;

FIG. 3 is a side view (exploded) of a fast fit mechanism adapted to couple a dynamo to a rotatable element according to some exemplary embodiments of the invention;

FIG. 4 is a side view (exploded) of a fast fit mechanism adapted to couple a dynamo to a rotatable element according to some exemplary embodiments of the invention;

FIG. 5a is an exploded perspective view of a turbine according to some exemplary embodiments of the invention;

FIG. 5b is an exploded perspective view of another turbine according to some exemplary embodiments of the invention;

FIG. 5c is a perspective view of a turbine as depicted in FIG. 5a after assembly;

FIG. 6a is a front view of turbines according to an exemplary embodiment of the invention arranged in an array;

FIG. 6b is a schematic representation of an array of turbines as in FIG. 6a indicating an exemplary configuration of rotational direction of individual turbines within the array;

FIG. 6c is a schematic representation of an array of turbines as in FIG. 6a indicating another exemplary configuration of rotational direction of individual turbines within the array;

FIG. 6d is a schematic representation of an array of turbines as in FIG. 6a indicating a third exemplary configuration of rotational direction of individual turbines within the array;

FIG. 6e is a schematic representation of an array of turbines as in FIG. 6a indicating a fourth exemplary configuration of rotational direction of individual turbines within the array;

FIG. 7 is a perspective view an array of turbines as depicted in FIG. 5b with rotatable elements and dynamos removed;

FIG. 8 is a schematic representation of an integrated system for electricity production including arrays of turbines according to an exemplary embodiment of the invention as well as solar panels and/or another energy source; and

FIG. 9 is a schematic representation of an exemplary malfunction detection system according to some embodiments of the invention.

### DETAILED DESCRIPTION OF EMBODIMENTS

Embodiments of the invention relate to wind powered turbines, kits for constructing them, and systems or apparatus comprising multiple turbines.

Specifically, some embodiments of the invention can be used to reduce noise and/or vibration produced by wind turbines and/or simplify maintenance of systems including wind turbines and/or integrate wind turbines into other system types (e.g. solar power systems.

The principles and operation of apparatus and systems according to exemplary embodiments of the invention may be better understood with reference to the drawings and accompanying descriptions.

Before explaining at least one embodiment of the invention in detail, it is to be understood that the invention is not limited in its application to the details set forth in the following description or exemplified by the Examples. The invention is capable of other embodiments or of being practiced or carried out in various ways. Also, it is to be understood that the phraseology and terminology employed herein is for the purpose of description and should not be regarded as limiting.

### Exemplary Bladeless Rotatable Elements

In some exemplary embodiments of the invention, the turbines employ bladeless rotatable elements. Some considerations relevant to construction of bladeless rotatable elements are described in co-pending international application publication WO 2011 /039750; which is fully incorporated herein by reference.

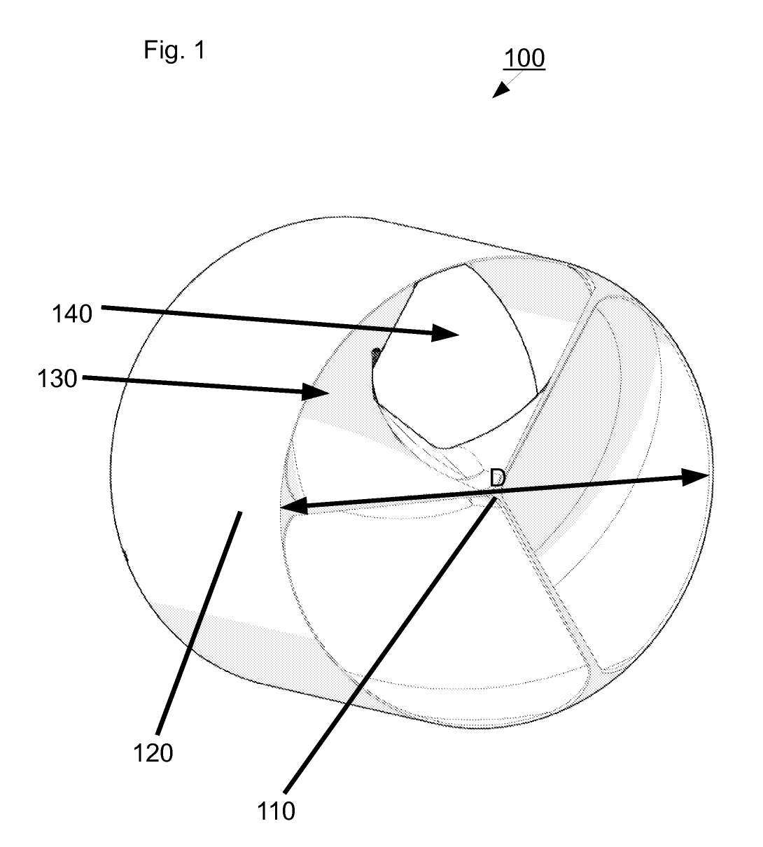

FIG. 1 depicts an exemplary bladeless rotatable element indicated generally as 100. According to various exemplary embodiments of the invention depicted element 100 can have a diameter D transverse to a point of attachment 110 to a drive train of less than 35, 25, 17, 10, 8, 6 or even 4 cm or intermediate or smaller sizes.

Depicted exemplary element 100 has a smooth outer surface 120. In the depicted exemplary embodiment, surface 120 is configured as a sleeve circumscribing element 100.

Element 100 is depicted at an angle so that both inlet ports 130 and outlet ports 140 are visible. Element 100 rotates in a counter clockwise direction in response to wind entering inlet ports 130.

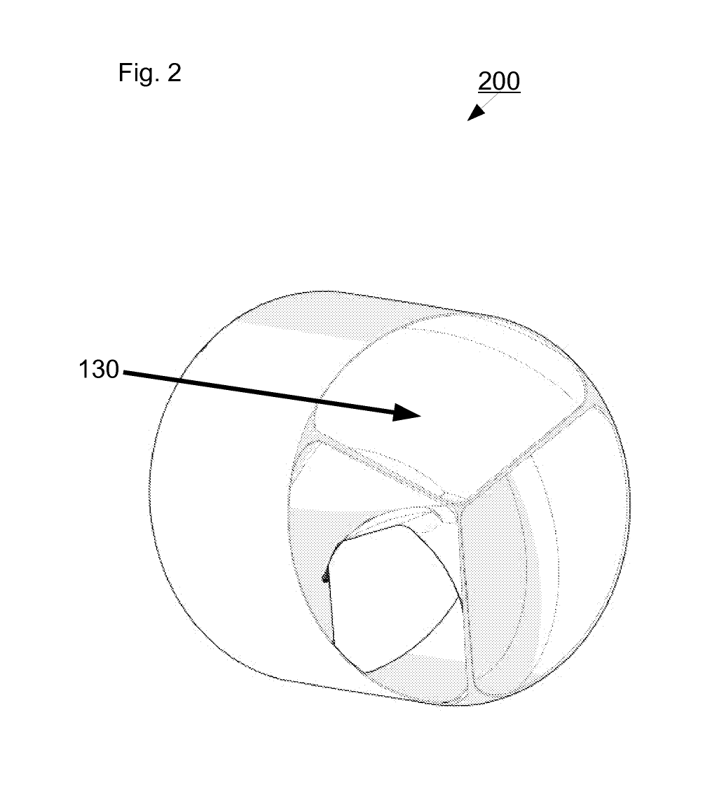

FIG. 2 depicts another exemplary bladeless rotatable element indicated generally as 200. Element 200 is similar to element 100 in, except that it is designed and configured to rotates in a clockwise direction in response to wind entering inlet ports 130.

### Exemplary Fast Fit Mechanisms

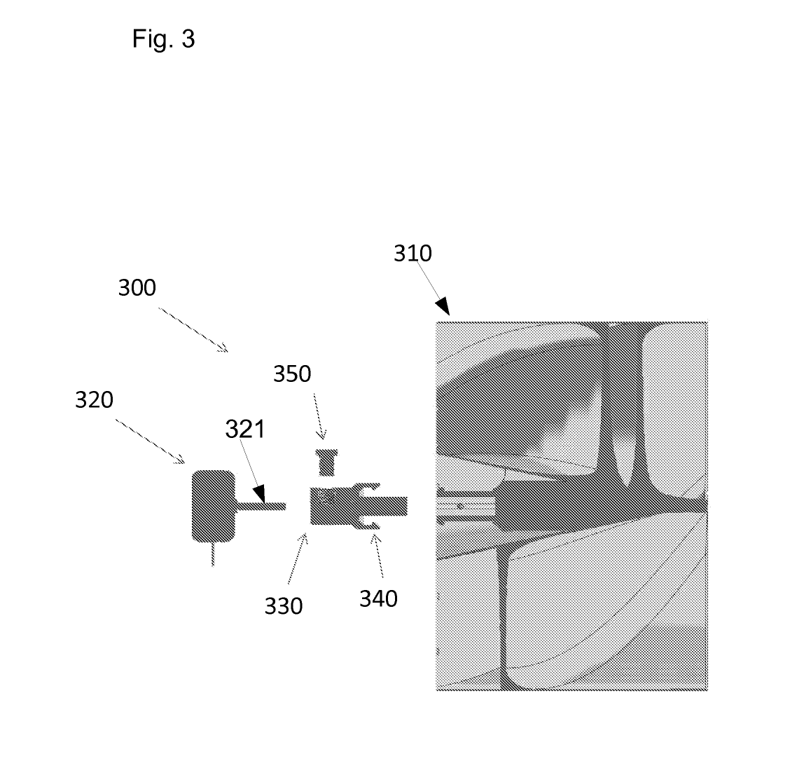

FIG. 3 is an exploded view of a fast fit mechanism indicated generally as 300. Depicted exemplary fast fit mechanism 300 can be used, for example, to couple a dynamo to a rotatable element. In the depicted exemplary embodiment, a rotatable element 310 is coupled to a snap to fit connector 330. A latch 340 prevents unwanted opening of the connection. In the depicted exemplary embodiment, a dynamo 320 is connected to snap to fit connector 330 and a screw 350 prevents a rotor axis 321 of dynamo 320 from slipping.

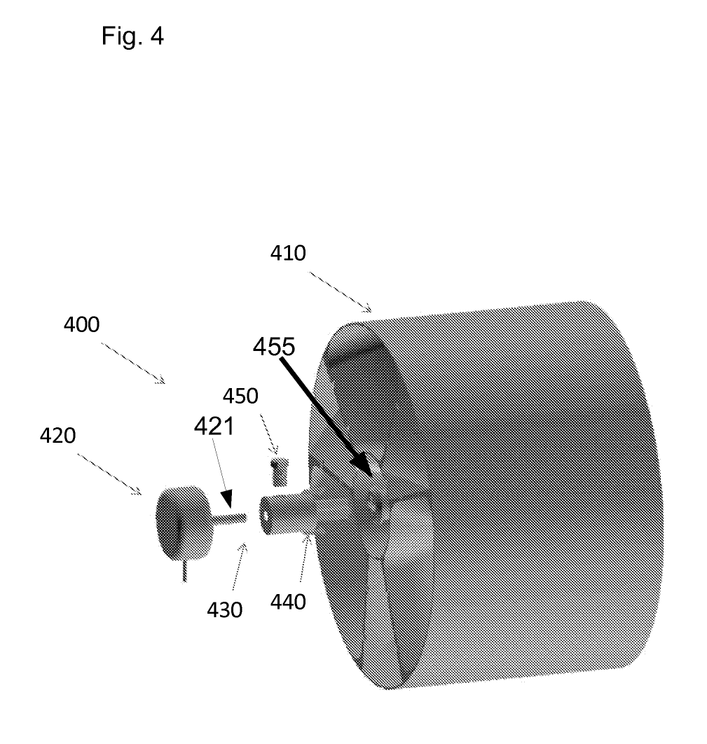

FIG. 4 is an exploded view of another exemplary fast fit mechanism indicted generally as 400. Depicted exemplary mechanism 400 casn be used, for example, to couple a dynamo to a rotatable element. In the depicted exemplary embodiment, a rotatable element 410 (of the same general type depicted in FIGS. 1 and 2) is coupled to fast fit connector 430. A latch 440 prevents unwanted opening of the connection. A dynamo 420 is connected to fast fit connector 430 a screw 450 prevents a rotor axis 421 of dynamo 420 from slipping.

### Exemplary Rregulation of Rotation Speed

In some embodiments, a rotation speed of the rotatable element(s) is adjustable by disturbing air flow. According to various exemplary embodiments of the invention disturbance of airflow is accomplished in different ways. In some embodiments, the rotation speed of a rotatable element (e.g. 100 or 200) is adjustable by opening a cavity (not depicted) in outer surfaces 120 of channels connecting ports 130 to ports 140. Alternatively or additionally, in some embodiments, rotation speed of the rotatable element (e.g. 100 or 200) is adjustable by modifying the area of at least one of inlet ports 130 and/or or outlet ports 140. Alternatively or additionally, in some embodiments the rotation speed of a rotatable element (e.g. 100 or 200) is adjustable by changing a helix angle of channels connecting ports 130 to ports 140.

### Exemplary Turbine Module

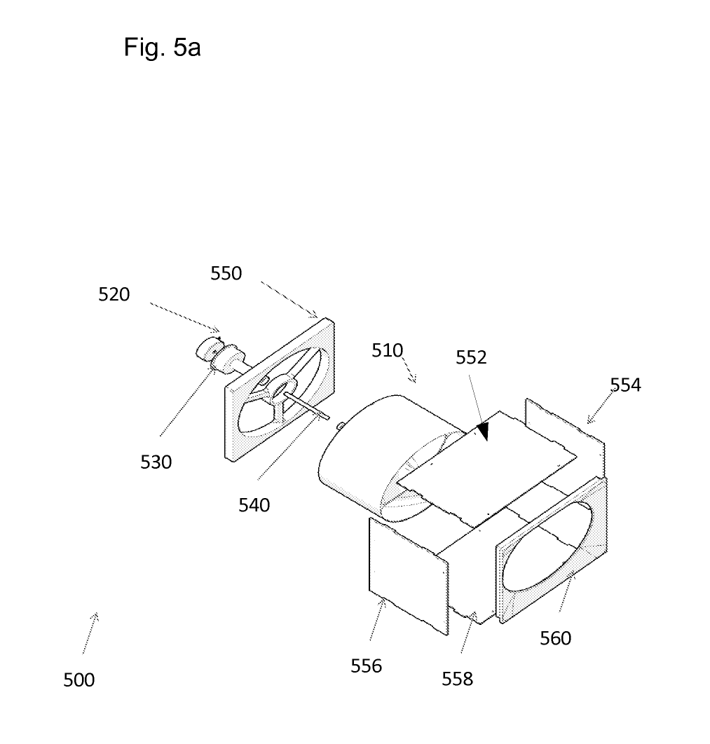

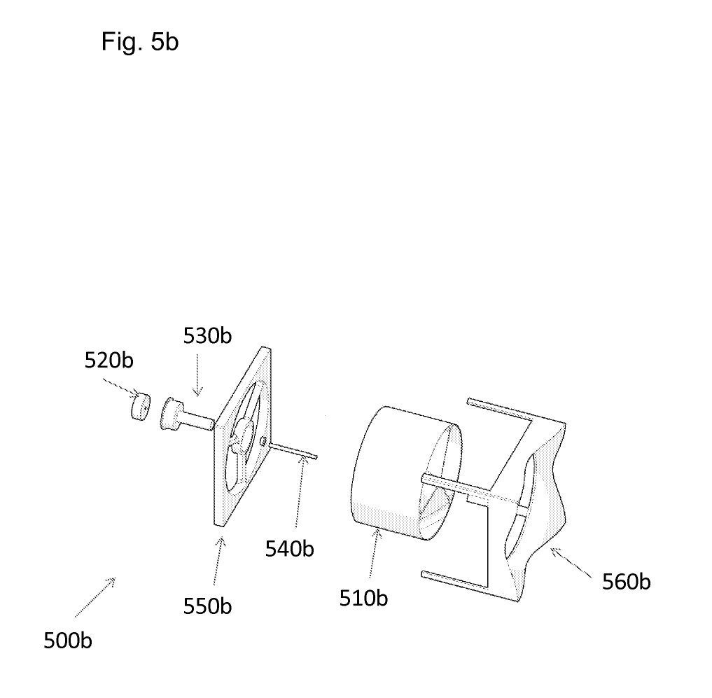

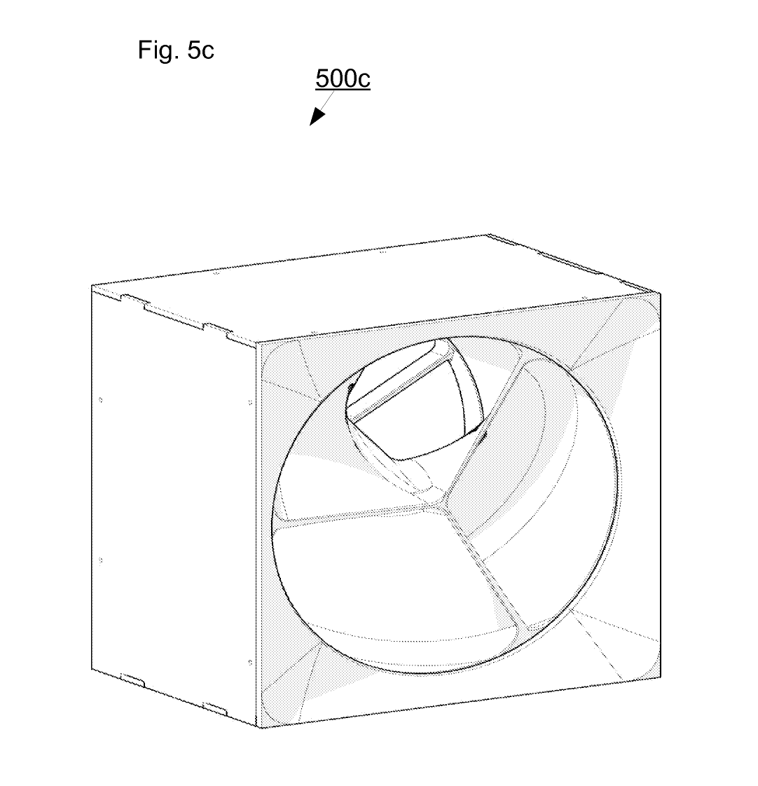

FIG. 5a is an exploded view of an exemplary turbine module suitable for use in some exemplary embodiments of the invention, indicated generally as 500. In the depicted exemplary embodiment, a rotatable element 510 (of the same general type depicted in FIGS. 1 and 2) is connected to a dynamo 520 by a drive train in the form of an axle 540 and by fast fit connector 530. In the depicted exemplary embodiment, fast fit connector 530 is attached the rear side 550 of a housing by a bearing (not shown). Additional housing panels 552, 554,556 and 558 are optionally connected to rear side 550 to form an enclosed housing. In the depicted exemplary embodiment, funnel front 560 is attached to the side panels 552, 554,556 and 558. Optionally, funnel front 560 serves to guide air into inlet ports (not visible in this view) of rotatable element 510.

FIG. 5b is an exploded view of an exemplary turbine module suitable for use in some exemplary embodiments of the invention, indicated generally as 500b. Module 500b is similar to module 500 except that the housing is not fully enclosed. In the depicted exemplary embodiment, rotatable element 510b is connected to the dynamo 520b by a drive train including axle 540b and fast fit connector 530b. In the depicted exemplary embodiment, fast fit connector 530b is attached the rear side 550b of the housing by a bearing (not shown). Optionally, funnel front 560b is attached to the rear side 550b to form an open housing.

In some exemplary embodiments of the invention, modules of the type depicted in FIGS. 5a and/or 5B are provided as a kit for construction of a turbine array. According to various exemplary embodiments of the invention the modules are provided pre-assembled or unassembled.

FIG. 5c is a perspective view of the turbine module of FIG. 5a after assembly indicated generally as 500c.

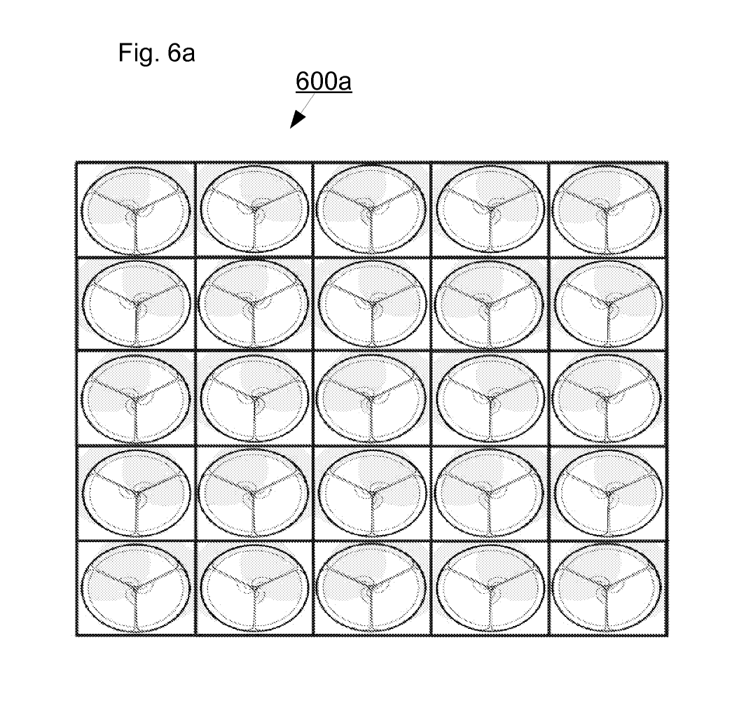

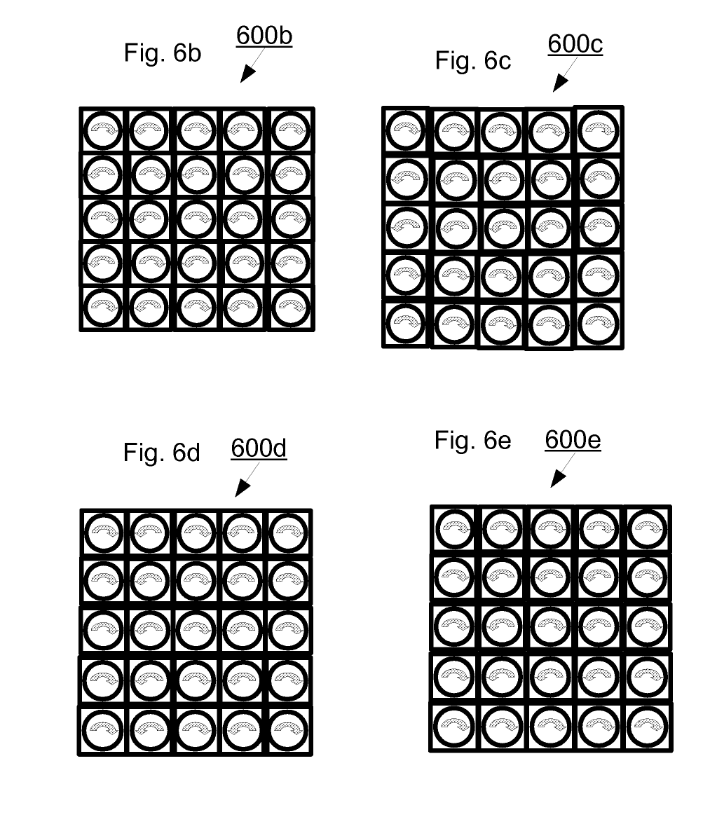

FIG. 6a is a front view of an apparatus, indicated generally as 600, including an array of turbines modules of the general type depicted in FIG. 5a and/or 5b.

FIGS. 6b, 6c, 6d and 6e are schematic representations of an array of turbines as in FIG. 6a indicating four different exemplary configurations of rotational direction of individual turbines within the array. Note that although 5 by 5 arrays are depicted, smaller or larger arrays represent additional embodiments of the invention. For example, the central 3 by 3 array in FIG. 6e is an embodiment of the invention.

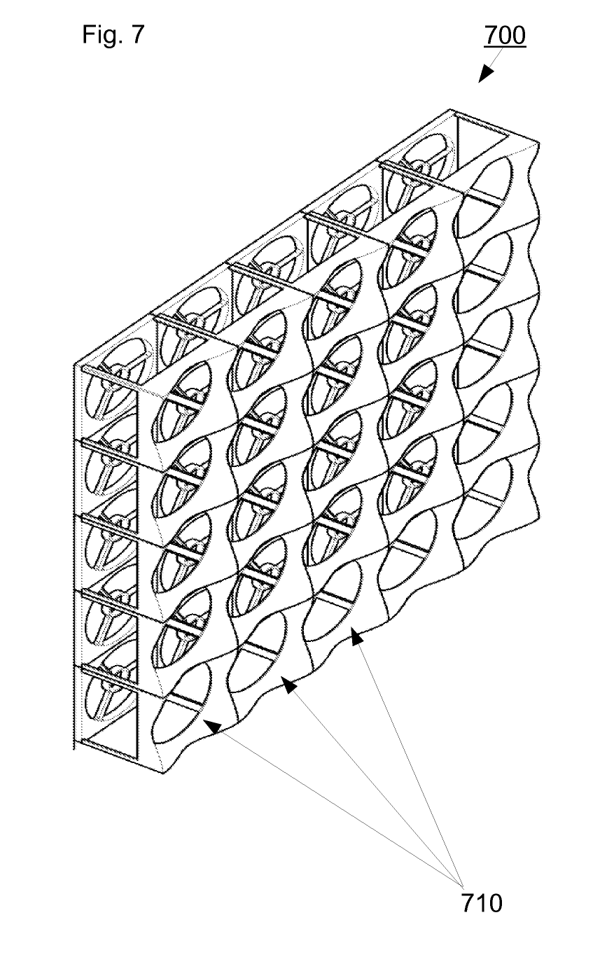

FIG. 7 is a perspective view of an array of turbine housings with turbines removed indicated generally as 700.

### First Exemplary Apparatus

Referring again to FIG. 4, some exemplary embodiments of the invention relate to an apparatus 400 including a bladeless rotatable element 410 with a smooth outer surface. In the depicted exemplary embodiment, rotatable element 410 is connected to a drive mechanism (421+430) which powers a dynamo 420. In operation incident wind on rotatable element 410 causes rotation which turns axle 421 causing dynamo 420 to output an electric current. Optionally, the current is a DC current. In the depicted exemplary embodiment, the drive mechanism includes a single axle 421 connected to both rotatable element 410 and said dynamo 420.

In the depicted exemplary embodiment, dynamo 420 resides within a volume 455 defined by rotatable element 410.

In some exemplary embodiments of the invention, apparatus 400 is fitted with a funnel element adapted to direct an airflow into one or more intake ports of said rotatable elements. (see 560 and 560b in FIGS. 5a and 5b respectively).

In some exemplary embodiments of the invention, rotatable element 410 of apparatus 400 has a diameter of less than 25 cm measured transverse to its connection to said drive mechanism. (See “D” in FIG. 1). In other exemplary embodiments of the invention, this diameter is considerably smaller as described in the context of FIG. 1.

Optionally, a rotation speed of rotatable element 410 is adjustable by disturbing a flow in one or more conduits in the rotatable element. Exemplary speed adjustment mechanisms are described in co-pending international application publication WO 2011 /039750; which is fully incorporated herein by reference.

In some exemplary embodiments of the invention, a plurality of apparatus 400 are provided arranged in an array (e.g. as depicted in FIG. 6a). In some exemplary embodiments of the invention, a first portion of rotatable elements in the array are adapted to rotate clockwise and a second portion of rotatable elements in said array are adapted to rotate counter clockwise (See FIGS. 6b, 6c, 6d and 6e for exemplary rotation configuration). In some embodiments, an array in which different turbines rotate in different directions contributes to a reduction in noise and/or vibration of the array as a whole.

### Second Exemplary Apparatus

Some exemplary embodiments of the invention, relate to an apparatus including an array of contiguous turbine housings (e.g. 700; FIG. 7) and a plurality of turbines (e.g. 400 of FIG. 4) installed in the housings. In some embodiments, a rotatable element in a first portion of the turbines is adapted to rotate clockwise and a rotatable element in a second portion of the turbines is adapted to rotate counter clockwise as depicted in FIGS. 6b, 6c, 6d and 6e. In some exemplary embodiments of the invention, the rotatable elements in the turbines are bladeless as depicted in FIGS. 1 and 2. Alternatively or additionally, in some embodiments a rotation speed of the rotatable element of the turbines is adjustable by disturbing a flow in one or more conduits in the rotatable element. Alternatively or additionally, in some embodiments the rotatable elements have a smooth outer surface (e.g. 120 in FIG. 1). One way to achieve a smooth outer surface is to circumscribe a sleeve about the rotatable element. In some exemplary embodiments of the invention, the rotatable element of each of the turbines includes an axle (e.g. 321 or 421 in FIGS. 3 and 4 respectively) powering a dynamo so as to output an electric current. Alternatively or additionally, in some embodiments a dynamo of each of said turbines resides within a volume defined by said rotatable element (see 455 in FIG. 4 for example). Alternatively or additionally, in some embodiments the apparatus includes a funnel element adapted to direct an airflow from between the turbines into one or more of the turbines (e.g. 560 and/or 560b in FIGS. 5a and 5b respectively). According to various exemplary embodiments of the invention the array includes at least 16, at least 32, at least 64, at least 128 or even at least 256 turbines per M².

### Exemplary Kit

Referring again to FIGS. 5a and 5b: Some exemplary embodiments of the invention, relate to a kit including a plurality of turbine modules (e.g. 500 or 500b), each of the modules including at least one turbine (e.g. 510 or 510b and a surrounding support structure, In some embodiments, each of turbine modules (e.g. 500 or 500b) is provided with a fast fit mechanism adapted for attachment to at least one additional turbine module.

In some embodiments, of the kit a first portion of the modules include exclusively turbines with a rotatable element adapted to rotate clockwise and a second portion of the modules comprise exclusively turbines with a rotatable element adapted to rotate counter clockwise. This is always the case if each module contains a single turbine as depicted in FIGS. 5a and 5b.

In some exemplary embodiments of the invention, (not depicted) at least some of the modules include more than 1 turbine (e.g. 2 or 4 turbines). According to these embodiments, at least a portion of the modules optionally include at least one turbine with a rotatable element adapted to rotate clockwise and at least one turbine with a rotatable element adapted to rotate counter clockwise.

In either case, assembly of the modules produces an array in which some of the rotatable elements rote clockwise and other rotatable elements rotate counterclockwise (See FIGS. 6b, 6c, 6d and 6e for examples).

Optionally, each of the turbines in the module includes a fast fit mechanism coupling the dynamo to the rotatable element (e.g. as depicted in FIGS. 3 and 4).

Alternatively or additionally, in some embodiments, each of the at least one turbine is provided as a pre-assembled turbine (e.g. as in FIG. 5c) including a fast fit mechanism attachable to the surrounding support structure. In other exemplary embodiments of the invention, each of the plurality of turbine modules is provided un-assembled (e.g. as in FIG. 5a and/or FIG. 5b).

Exemplary Array with Unified Support Structure

Referring now to FIG. 7, some embodiments of the invention relate to n apparatus incliding a support structure 700 including a number of turbine receptacles arranged in an array and a corresponding number of turbines (e.g. 300 or 400) engaged and retained in the receptacles, each turbine having a bladeless rotatable element as described hereinabove. In some embodiments, a fast fit mechanism connects the bladeless rotatable element to a drive train of each of said turbines (see description of FIGS. 3 and 4 hereinabove for exemplary details). Optionally, this configuration contributes to ease of maintenance if a single rotatable element malfunctions.

Alternatively or additionally, in some embodiments, the apparatus includes a fast fit mechanism connecting a dynamo of each of the turbines to the support structure. This is analogous to insertion of axle 540b in fast fit mechanism 530b through rear wall 550b in FIG. 5b.

Alternatively or additionally, in some embodiments, the apparatus is corresponding number of wind funnels 710 (FIG. 7) connected to the support structure, each of wind funnels 710 adapted to direct a flow of air towards the rotatatable element (not depicted in FIG. 7). In some embodiments, the apparatus includes fast fit mechanisms (not depicted) which connect wind funnels 710 to the support structure. In other exemplary embodiments of the invention, wind funnels 710 are provide as a cover plate with a corresponding number of wind funnels adapted and arranged to direct a flow of air towards the rotatable element, with the cover plate being connected to the support structure, optionally by a fast fit mechanism.

### Exemplary Malfunction Detection System

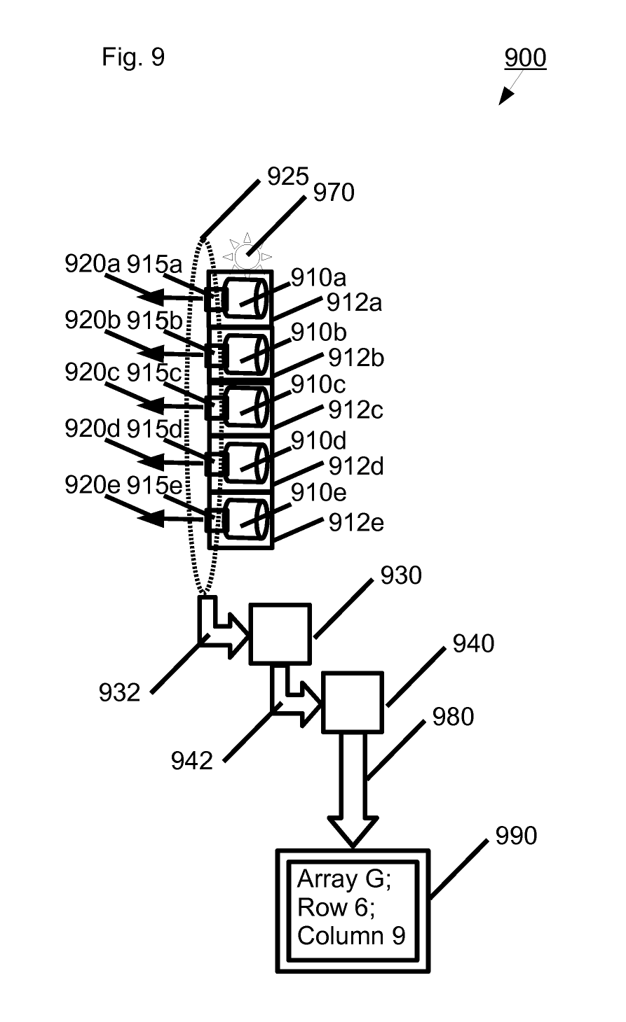

FIG. 9 is a schematic representation of an exemplary malfunction detection system according to some exemplary embodiments of the invention indicated generally as system 900.

In the depicted exemplary embodiment, system 900 includes a plurality of turbines installed in an array of contiguous housings. In FIG. 9, five housings 912a ; 912b ; 912c ; 912d and 912e are depicted for simplicity although a much larger number may actually be present (e.g. as in FIG. 6a or 7). Alternatively or additionally, a system 900 may concurrently monitor multiple arrays of turbines.

In the depicted exemplary embodiment, each turbine is represented as a rotatable element 910 (a-e are depicted for simplicity) and a dynamo 915 (a-e are depicted for simplicity) producing an output current 920 (a-e are depicted for simplicity). Depicted exemplary system 900 includes a current monitor 925 (represented schematically as a dotted oval) measuring output currents 920a to 920e from dynamos 915a to 915e of each of the turbines. In the depicted exemplary embodiment, logic circuitry 930 is adapted to receive measurements 932 from current monitor 925 and determine if one or more turbines in the plurality malfunctions and indicate malfunctions to a reporting mechanism 940 (e.g. by providing malfunction indication 942). In some embodiments, logic circuitry 930 is adapted to determine which of the turbines malfunctions and identify the malfunctioning turbine(s) to reporting mechanism 940.

Optionally, identifications of specific turbines is accomplished using an addressing system. In the depicted exemplary embodiments of FIGS. 6b, 6c, 6d and 6e a row/column address system is appropriate. In other exemplary embodiments of the invention, other address systems may be appropriate. Optionally, the logic circuitry includes a program module installed on a microprocessor. The microprocessor may reside, for example, in a standards desktop or laptop computer. In some exemplary embodiments of the invention, the reporting mechanism includes one or more visual indicators. Optionally, the visual indicator are LEDs (e.g. 970) provided on the array of contiguous housings. According to these embodiments, logic circuitry 930 may directly activate the reporting mechanism. In some exemplary embodiments of the invention, a single indicator 970 indicates a problematic array of turbines. Alternatively or additionally, similar indicators may be provided on individual housings 912 to identify a specific malfunctioning turbine. In some embodiments, such visual indicators provide an additive or synergistic contribution to fast fit connectors in efforts to maintain a large array of small turbines.

In some exemplary embodiments of the invention, logic circuitry 930 employs a comparison algorithm. For example, if monitor 925 measures 3, 4 or 5 contiguous turbines in a single column, in some embodiments logic circuitry identifies an outlier in the group (e.g. a a current 920 that is 25, optionally 50% lower than the average of the group. In some embodiments, logic circuitry 930 reports the outlier to reporting mechanism 940 by issuing a malfunction indication 942.

In other exemplary embodiments of the invention, logic circuitry issues malfunction indication 942 only after confirmation is received. Confirmation might be, for example, a series of two or three repeated measurements of current 920 from the same turbine indicating it is an outlier. Optionally, these measurements are purposely spread over a relatively long time (e.g. minutes to hours). Alternatively or additionally, these confirmation measurements measure the suspected malfunctioning turbine in different contexts (e.g. row; column; diagonal and as the center of four or eight surrounding turbines). In some embodiments, logic circuitry 930 issues commands to monitor 925 to perform these confirmation measurements. In other exemplary embodiments of the invention, monitor 925 performs measurements independently and logic circuitry 930 makes the necessary confirmation comparisons as data become available.

Alternatively or additionally, in some embodiments, the reporting mechanism 940 provides visual indicators on a computer monitor 990 (e.g. as a WWW site; optionally with restricted access) or a monitor of a portable communication device (e.g. smartphone). Alternatively or additionally, in some embodiments, reporting mechanism 940 issues a digital announcement 980. According to various exemplary embodiments of the invention digital announcements may be in any convenient format including, but not limited to SMS and e-mail. Optionally, the digital announcement indicates an array and/or a specific address with an array. In the depicted exemplary embodiment, digital announcement 980 is displayed on display screen 990.

In some exemplary embodiments of the invention, a rotatable element of each of the turbines has a diameter of less than 35 cm measured transverse to its connection to a drive mechanism (see D in FIG. 1). Optionally, this diameter is much smaller as described hereinabove.

### Exemplary Integrated System

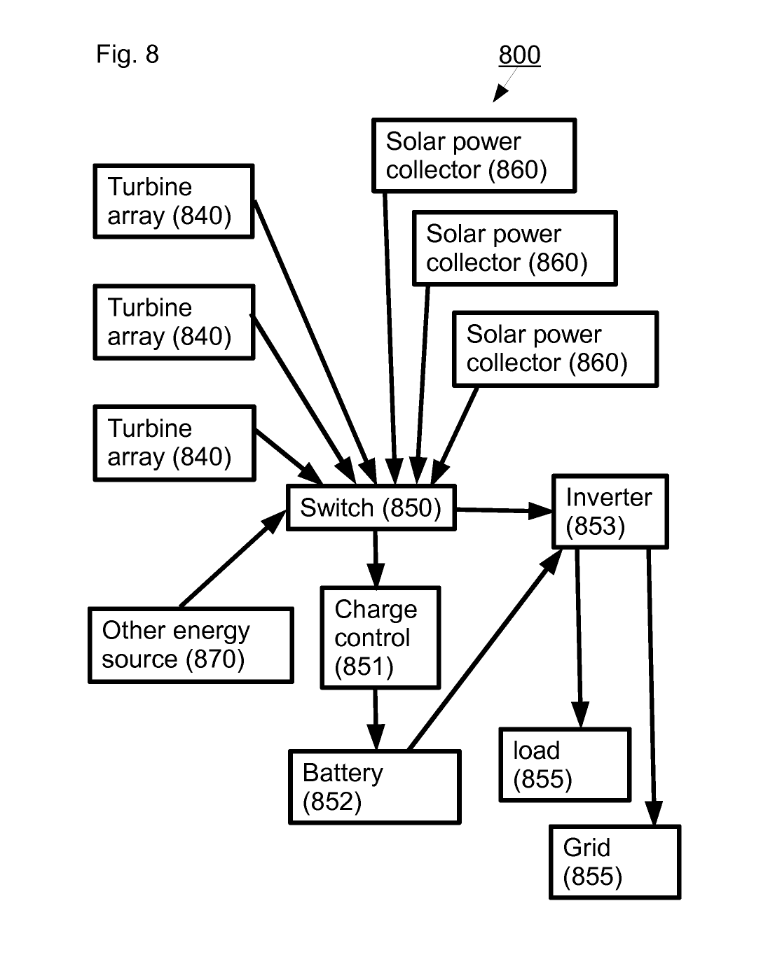

FIG. 8 depicts an exemplary integrated system for generation of electric power indicated generally as 800. Depicted system 800 includes one or more turbines or turbine arrays 840 as described hereinabove and a switch 850 transferring an output current from array(s) 840 a power grid 855 through an inverter 853. The depicted system also includes at least one other power source (e.g. solar power collectors 860) transferring an output current to grid 855 through switch 850.

According to various exemplary embodiments of the invention switch 850 is connected to inventor 853 directly or through charge control 851 and battery 852. From the invertor 853 the electricity can be supplied directly to load 854 or to grid 855. Such as system allows an existing system, e.g. a solar power system, to be retro fitted to take advantage of wind power. Such a retro fit takes advantage of the existing infrastructure (e.g. switch 850 and/or inverter 853 and/or charge control 851 and/or battery 852)

It is expected that during the life of this patent many renewable energy sources will be developed and the scope of the invention is intended to include all such new technologies a priori.

As used herein the term “about” refers to ±10%.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

Specifically, a variety of numerical indicators have been utilized. It should be understood that these numerical indicators could vary even further based upon a variety of engineering principles, materials, intended use and designs incorporated into the various embodiments of the invention. Additionally, components and/or actions ascribed to exemplary embodiments of the invention and depicted as a single unit may be divided into subunits. Conversely, components and/or actions ascribed to exemplary embodiments of the invention and depicted as sub-units/individual actions may be combined into a single unit/action with the described/depicted function.

Alternatively, or additionally, features used to describe a method can be used to characterize an apparatus and features used to describe an apparatus can be used to characterize a method.

It should be further understood that the individual features described hereinabove can be combined in all possible combinations and sub-combinations to produce additional embodiments of the invention. The examples given above are exemplary in nature and are not intended to limit the scope of the invention which is defined solely by the following claims.

Each recitation of an embodiment of the invention that includes a specific feature, part, component, module or process is an explicit statement that additional embodiments exist which do not include the recited feature, part, component, module or process.

Specifically, the invention has been described in the context of wind power but might also be used with other compressible fluids.

All publications, references, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

The terms “include”, and “have” and their conjugates as used herein mean “including but not necessarily limited to”.

1-8. (canceled)

9. An apparatus comprising:
(a) an array of contiguous rotatable elements housings; and
(b) a plurality of rotatable elements installed in said housings, wherein a rotatable element in a first portion of said array is adapted to rotate clockwise and a rotatable element in a second portion of said array is adapted to rotate counter clockwise.

10. Apparatus according to claim 9, wherein said rotatable elements are bladeless.

11. (canceled)

12. Apparatus according to claim 9, wherein said rotatable elements have a smooth outer surface.

13. Apparatus according to claim 9, wherein said rotatable elements are circumscribed by a sleeve.

14. Apparatus according to claim 9, wherein said rotatable element of each of said turbines comprises an axle powering a dynamo so as to output an electric current.

15. (canceled)

16. Apparatus according to claim 9, comprising a funnel element adapted to direct an airflow from between said rotatable elements into one or more of said rotatable elements.

17. Apparatus according to claim 9, wherein said array comprises at least 16 rotatable elements per M².

18-24. (canceled)

25. An apparatus according to claim 14, comprising a fast fit mechanism connecting said rotatable element to a drive train of each of said dynamo.

26-29. (canceled)

30. A system comprising:
(a) a plurality of turbines installed in an array of contiguous housings;
(b) a current monitor measuring an output current from a dynamo of each of said turbines;
(c) logic circuitry adapted to receive measurements from said current monitor and determine if one or more turbines in said plurality malfunctions and indicate malfunctions to a reporting mechanism; and
(d) said reporting mechanism.

31. A system according to claim 30, wherein said logic circuitry is adapted to determine which of said turbines malfunctions and identify said malfunctioning turbine(s) to said reporting mechanism.

32. A system according to claim 30, wherein said logic circuitry comprises a program module installed on a microprocessor.

33. A system according to claim 30, wherein said reporting mechanism includes one or more visual indicators.

34. A system according to claim 30, wherein said reporting mechanism issues a digital announcement.

35. A system according to claim 30, wherein a rotatable element of each of said turbines has a diameter of less than 35 cm measured transverse to its connection to a drive mechanism.

36. A system comprising:
(a) the apparatus according to claim 9;
(b) a switch transferring an output current from said apparatus or systems to a power grid through an inverter; and
(c) at least one other power source transferring an output current to said grid through said switch.

37. A system comprising:
(a) the system of claim 30;
(b) a switch transferring an output current from said apparatus or systems to a power grid through an inverter; and
(c) at least one other power source transferring an output current to said grid through said switch.
